(19) United States
(12) Patent Application Publication
(10) Pub. No.: US 2017/0161443 A1
(43) Pub. Date: Jun. 8, 2017

(54) Hospital Operations System

(71) Applicant: Qwaltec, LLC, Tempe, AZ (US)

(72) Inventors: Robert Bassham, Tempe, AZ (US); Jesue Garza, Tempe, AZ (US)

(21) Appl. No.: 14/961,626

(22) Filed: Dec. 7, 2015

(51) Int. Cl. G06F 19/00

(52) U.S. Cl. CPC G06F 19/327; G06F 19/322; G06F 19/3425

(57) ABSTRACT

A hospital operations system is provided which centralizes, processes, prioritizes, and presents vast data generated by hospital systems and software applications and partially controls devices, alerts, and overall patient care within hospital systems for greater efficiency and provision of improved patient care, patient safety, and hospital efficiency beyond what currently exists. The hospital operations system capabilities are enabled via dedicated workstation computing devices located in a single location with a video wall for displaying important information from all workstation computing devices. The hospital operations system includes a software product for centralizing decentralized hospital systems by providing instructions allowing software applications on the hospital systems to communicate with a user interface and with each other. The hospital operations capabilities include, without limitation, management and/or monitoring of: patient flow from admission to discharge; hospital network, equipment and software performance; patient physiological data; hospital resources; provision of an infrastructure for telemedicine; near misses and adverse events; situational awareness of hospital-wide data; coordination of emergency crisis responses; and an interface between operations and a hospital simulation center.

### CROSS REFERENCE TO RELATED APPLICATION

This application claims priority from U.S. Patent Application No. 62/088,131, filed Dec. 5, 2014 and entitled “Hospital Operations system,” which is incorporated entirely herein by reference.

### BACKGROUND OF THE INVENTION

Technical Field

This invention relates generally to a hospital management system and more particularly to a hospital operations system for centralized management of all hospital operations.

State of the Art

Hospital operations generally require the use of many different isolated systems. For example, a hospital may have a system for patient planning and scheduling, a system for bed management, a system for network and equipment monitoring, a system for hospital resource management, a system for physiological monitoring, a system for management of near misses and adverse events, a system for hospital management situational awareness, a system for emergency response coordination, a system for electronic health record/electronic medical record (“EHR/EMR”) interfaces, and a system for finance and insurance. Systems currently in use in hospitals typically do not communicatively interface with each other, and this negatively affects patient safety, the quality of patient care, the efficiency of healthcare delivery by healthcare professionals and other hospital staff, and the optimization of hospital operating costs to result in optimal hospital profits.

Accordingly, there is a need in the field of hospital management systems for a hospital operations system that centralizes a majority of hospital operational systems to increase management efficiency, decrease staff and employee stress, and maximize profits while providing superior patient care by maximally and efficiently coordinating hospital operational systems.

### SUMMARY OF THE INVENTION

The present invention relates to a hospital operations system (“HOS”) to centralize hospital systems for greater efficiency and a higher standard of patient care, increase patient safety, and improve hospital efficiency beyond what currently exists.

The HOS provides a centralized operations system that delivers real-time information, which may include continuous patient assessment; patent planning and scheduling; bed management and staffing; instantaneous monitoring and management of medical equipment and supplies; hospital resource management; real-time monitoring of patient physiological data; telemedicine and telemonitoring; anticipation, detection, analysis, and mitigation of adverse events and “near misses;” hospital management situational awareness; emergency response coordination; electronic health record (“HER”)/electronic medical record (“EMR”) interfaces; financial and insurance information; and an interface with a simulation center for recreation of critical events in high fidelity.

The HOS simultaneously monitors a vast amount of complex data from a large number of inputs; internally processes, assesses, and stratifies the data; and coordinates presentation of the data to individual decentralized systems which effect the safe and efficient execution of the hospital utilizing available resources. Existing hospital healthcare delivery systems generate vast amounts of data from a large number of sources which human operators must assess, determine, and execute actions to optimize the health and safety of individual human patients. Because of the range and complexity of human disease states and the number of inpatients and outpatients cared for in even a relatively small hospital or hospital system, hospital healthcare delivery is exceedingly complicated. And although human lives depend upon proper hospital management, current hospital operation systems are lacking interconnected computerized device management systems with the broadly integrated connectivity and other elements described herein in the disclosure of embodiments of the present invention.

Disclosed is a hospital operations system comprising an application programming interface comprising a plurality of instructions operating on a computing device; a plurality of decentralized hospital systems communicatively coupled to the application programming interface comprising at least two of an operations management system, an emergency coordination system, a resource management system, a patient planning and scheduling system, a patient physiological data monitoring system, and a network and equipment monitoring system, wherein each decentralized hospital system comprises an operator workstation computing device comprising a software application; and a user interface, wherein the application programming interface comprises instructions communicatively coupling the workstation computing devices of the plurality of decentralized hospital systems and displays information to the operator of the workstation computing device; a plurality of remote data inputting devices communicatively coupled to the computing device operating the application programming interface; wherein the remote data inputting devices communicate remote data comprising patient physiological data, medical device operational status data, patient laboratory test data, patient radiology test data, hospital physical plant systems data, hospital equipment and supply inventory data; hospital equipment operational status data; patient scheduling data, hospital employee scheduling data; computer network monitoring data; community emergency systems response data; and combinations thereof; wherein the computing device processes the remote data according to an instruction of the application programming interface, assigns a priority to each remote datum, and communicates the remote datum based upon the assigned priority to the software application of at least one of the operator workstation computing devices to comprehensively coordinate hospital operations between the plurality of decentralized hospital systems.

In some embodiments, the computing device is communicatively coupled to a device comprising a decentralized hospital system, wherein the computing device changes an operation of the device. In some embodiments, the device is a medical device coupled to a patient.

In some embodiments, the workstation computing devices of the plurality of decentralized hospital systems are located in a single location. In some embodiments, the hospital operations system further comprises an observation area with a line-of-site viewpoint of the workstation computing devices.

In some embodiments, the hospital operations system further comprises a second workstation computing device communicatively coupled to the application programming interface; a teleconferencing interface; and a conference room display communicatively coupled to the second workstation computing device and the teleconferencing interface, wherein the conference room display displays information from the plurality of decentralized hospital systems to a conference participant.

In some embodiments, the hospital operations system further comprises a video wall comprising a plurality of monitors communicatively connected to the application programming interface.

In some embodiments, the hospital operations system further comprises a simulation software application operating on the computing device; a simulation data bank; and a simulation data interface communicatively coupled with the application programming interface, wherein the simulation software application processes data stored in the simulation data bank to display a training scenario on the user interface, wherein the training scenario simulates critical events for training of an operator.

Disclosed is a hospital operations system comprising a second software application operating on a central server comprising a processor; a memory; a database; and a communications interface; a plurality of remote data input devices communicatively coupled to the central server comprising patient physiological data, medical device operational status data, patient laboratory test data, patient radiology test data, hospital physical plant systems data, hospital equipment and supply inventory data; hospital equipment operational status data; patient scheduling data, hospital employee scheduling data; computer network monitoring data; community emergency systems response data; and combinations thereof; a plurality of decentralized hospital systems communicatively coupled to the central server comprising at least two of an operations management system, an emergency coordination system, a resource management system, a patient planning and scheduling system, a patient physiological data monitoring system, and a network and equipment monitoring system., wherein each decentralized hospital system comprises a workstation computing device comprising a third software application; and a user interface, wherein the second software application comprises instructions communicatively coupling the workstation computing devices of the plurality of decentralized hospital systems and displays information to an operator of the workstation computing device; wherein the central server comprehensively coordinates hospital operations based upon the plurality of remote data input devices.

In some embodiments, the central server comprises an enterprise software. In some embodiments, the central server comprises a middleware. In some embodiments, the central server comprises a glueware.

Disclosed is a hospital operations system comprising an application programming interface operating on a computing device; a plurality of decentralized hospital systems, comprising an operations management system; a resource management system; and any one of the group of systems consisting of an emergency coordination system, a patient planning and scheduling system; a patient physiological monitoring system, and a network and equipment monitoring system, wherein the computing device is communicatively coupled to the plurality of decentralized hospital systems; wherein the application programming interface provides instructions causing the plurality of decentralized hospital systems to coordinate any one of a flow of a plurality of patient care events, an ordering of hospital supplies, a scheduling of hospital employees and medical staff, a dispatch of a patient care provider in response to a change in patent physiological status; a transportation of a patient between physically distinct locations within a hospital system; a transportation of a patient between a physical location remote from a hospital system facility and the hospital system facility; and a coordination of a municipal emergency response system personnel.

In some embodiments, each decentralized hospital system comprises a workstation computing device comprising a software application and a user interface, wherein the workstation computing device is communicatively coupled to the application programming interface; displays information to a user through the user interface; and receives instructional inputs from the user through the user interface.

The foregoing and other features and advantages of the present invention will be apparent from the following more detailed description of the particular embodiments of the invention, as illustrated in the accompanying drawings.

### BRIEF DESCRIPTION OF THE DRAWINGS

Some of the embodiments will be described in detail, with reference to the following figures, wherein like designations denote like members:

FIG. 1 is a schematic representation of a hospital operations system;

FIG. 2 is a schematic view of workstation computing device layout of a hospital operations system;

FIG. 3 is an additional schematic representation of a hospital operations system;

FIG. 4 is an additional schematic representation of a workstation computing device layout of a hospital operations system;

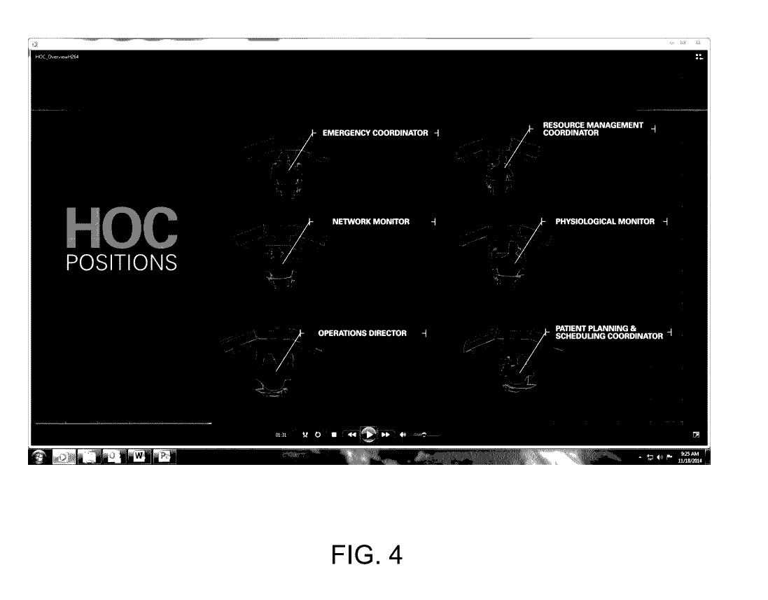

FIG. 5 is an additional schematic representation of a workstation computing device of a hospital operations system;

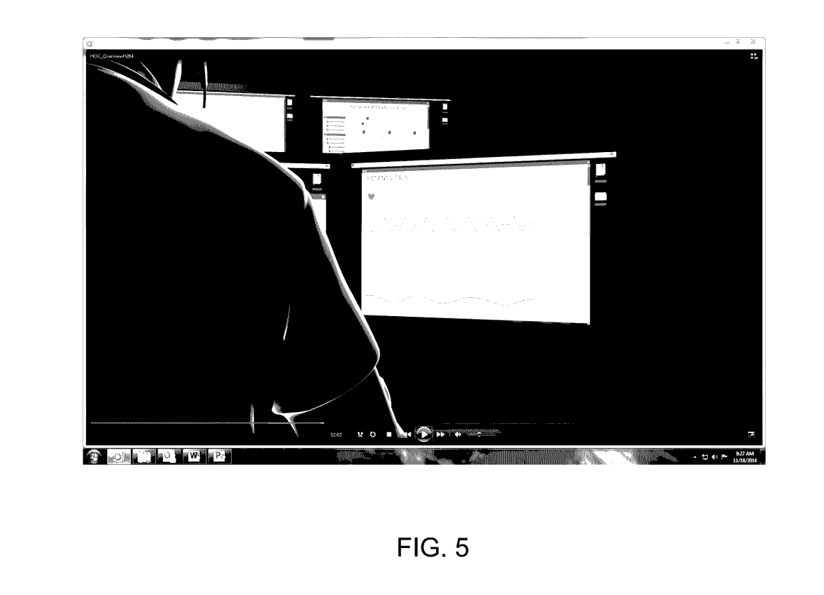

FIG. 6 is a schematic representation of a plurality of workstation computing devices of a hospital operations system;

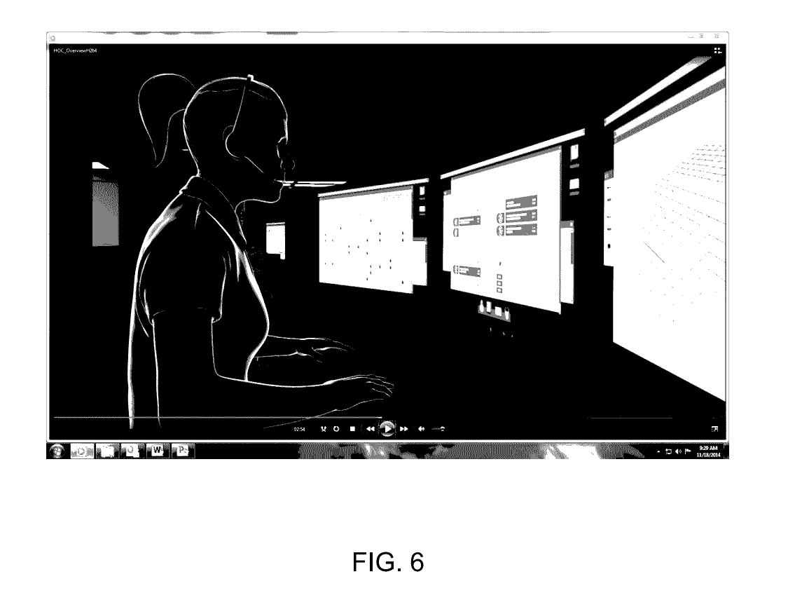

FIG. 7 is a second schematic representation of a plurality of workstation computing devices of a hospital operations system;

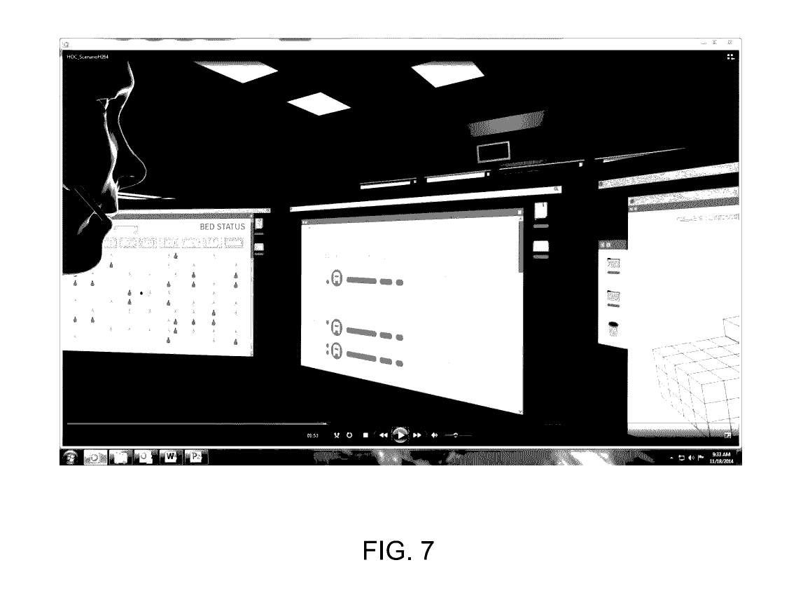

FIG. 8 is an example timeline diagram of a near-miss adverse event managed by a hospital operations system; and

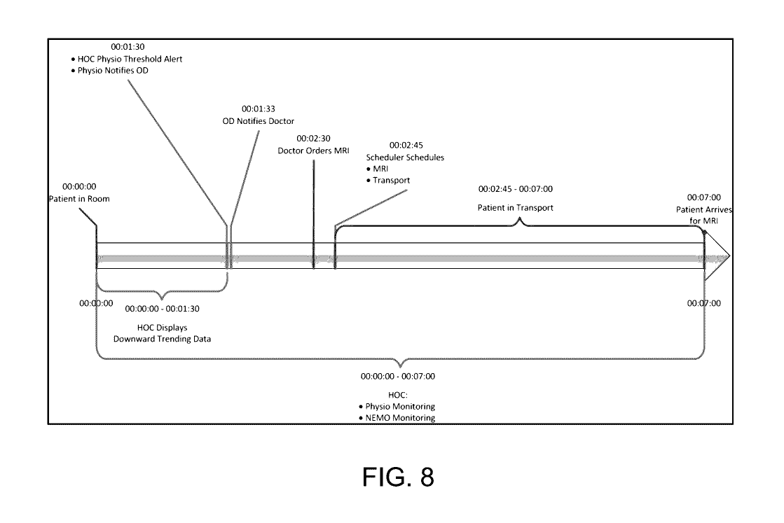

FIG. 9 is a chart illustrating relationships between functions and capabilities of a hospital operations system.

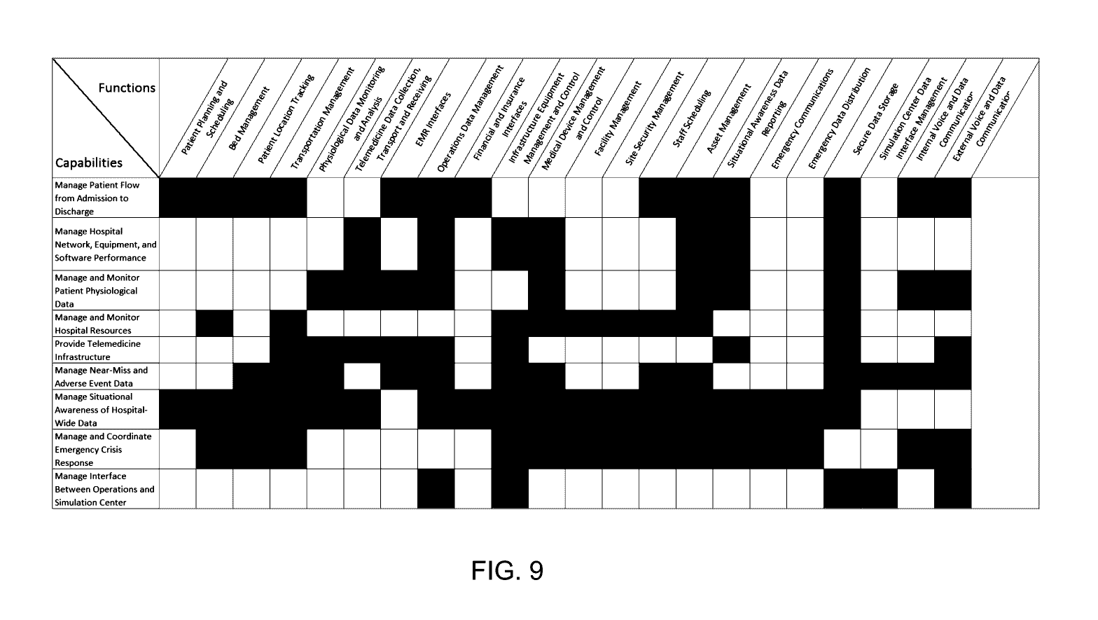

### DETAILED DESCRIPTION OF EMBODIMENTS OF THE INVENTION

As discussed above, embodiments of the present invention relate to a hospital operations system (“HOS”) for centralizing and coordinating hospital systems management to improve operational efficiency, patient care, resource management, and increase patient safety beyond levels which currently exist.

The HOS's capabilities are enabled via dedicated workstation computing devices and HOS staff positions, which may include one or more operations directors, physiological monitors, network and equipment monitors, patient planning and scheduling coordinators, resource management coordinators, and emergency coordinators of a number and combination suited to specific characteristics of the hospital, such as number of inpatient beds; outpatient services provided; scope of care, including specialty care; demographics of the patient population; and like factors.

In operations, the HOS requires various hardware and software to implement the capabilities of the HOS. An application programming interface (“API”) operating on a computing device, such as a centralized server in one non-limiting example, comprises instructions to process data collected from a plurality of remote data inputting devices physically located throughout the hospital system and communicatively coupled to the computing device operating the API. The API operates to organize and assess the data based upon coded instructions, prioritize the data, and then communicate the data based upon an assigned category and priority to one or more workstations comprising multiple decentralized hospital systems. Hospital operations, including patient care operations, are effected from a plurality of decentralized hospital systems comprising individual operator workstations.

In some non-limiting example embodiments, the HOS comprises a central operations room, an executive briefing room and an observation and visiting area.

In some embodiments, a central operations room facilitates efficient event response time and team communications through collocation of operators; a flexible, scalable, open architecture; dedicated workstation computing devices; and a video wall. The operations room's flexible and scalable design allows the number of workstation computing devices to increase or decrease based on current patient volumes and hospital needs.

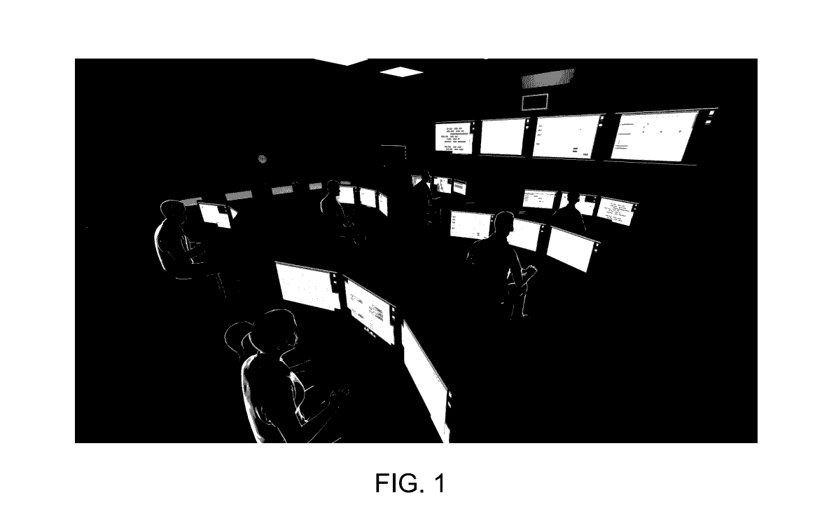

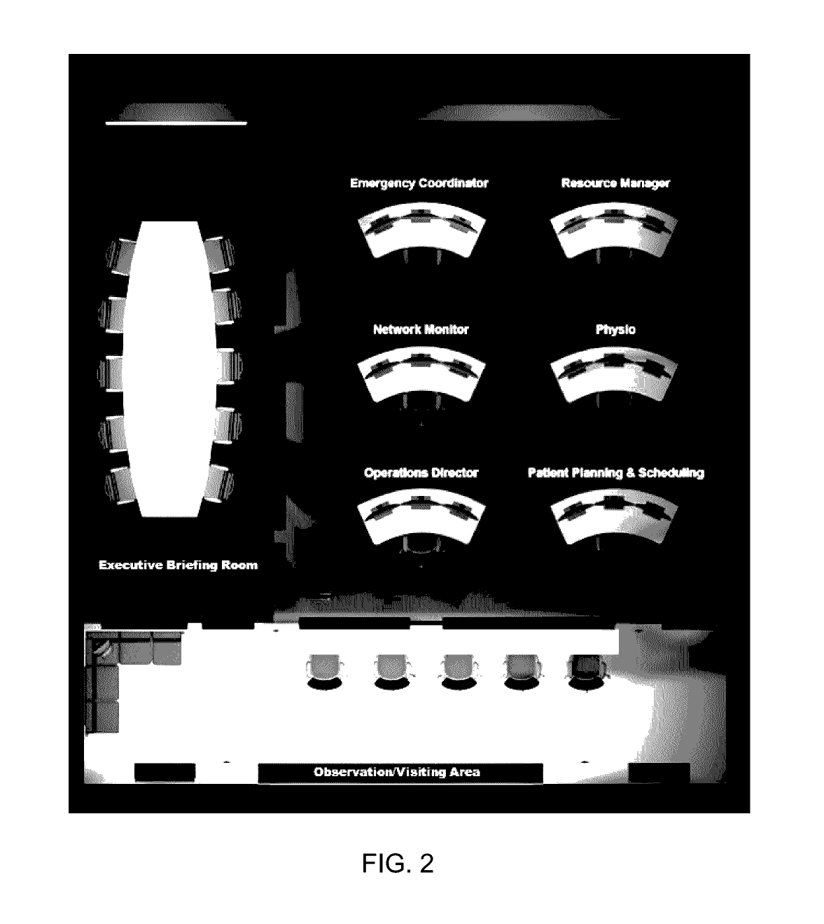

FIG. 1 and FIG. 2 depict a HOS 100. HOS 100, in some embodiments, comprises an API 107, a plurality of decentralized hospital systems 102, and a plurality of remote data inputting devices 108.

Application programming interface (API) 107 comprises a plurality of software instructions operating on a computing device. The computing device, in some embodiments, is a central server, which may be physically located within a hospital system facility, in some embodiments, or at any location remote from the hospital system facility in a “cloud-based” configuration, in some embodiments. These example locations of the computing device are not meant to be limiting. API 107 integrates functions of decentralized hospital systems 102 by executing at least two primary functions, in some embodiments: 1) comprehensive data collection from remote data inputting devices 108 with processing, prioritizing, and communication of the data according to priority to one or more decentralized hospital systems 102; and 2) control of devices within HOC 100 by automated controls, presentation of data to human operators via a user interface 103, or a combination thereof. Any hospital system, from a small rural single-facility hospital to a large, multi-facility urban or university hospital system must collect, interpret, prioritize, and act upon almost incomprehensibly vast amounts of data collect from data inputting devices 108. Safe patient care depends on accurate processing and interpretation of these data. Because management of the large amount of patient-collected data with interpretation and decision-making based upon evidence-based medical care is exceedingly difficult, if not impossible, by a healthcare provider, such as a physician or a nurse, instructions comprising a first software 103 comprising API 107 facilitates safe and efficient collection, interpretation, and decision making based upon data content and known evidence-based best medical practices from the vast body of medical literature.

Additionally, hospitals require management of a plurality of systems not directly related to patient care, but to operation of building, equipment, business, staffing, and like-related systems. Some non-limiting examples include operation of the physical plant, including HVAC, electrical, plumbing, building security, lighting, etc.; operation of medical equipment including complicated patient fluid and tissue chemical laboratory analytic equipment, individual items of patient monitoring equipment such as vital sign monitors, hemodynamic monitors, and the like for individual patients; operation and collection of digital data from radiographic equipment; specialized temperature, negative airflow, and additional specialized environmental requirements for operating rooms, obstetrical suites, emergency rooms, and the like; management of staffing requirements including constantly updated real-time staff needs, at times involving thousands of employees from dozens of individual units and departments; monitoring of large computer networks, hospital intranets, hospital Internet of Things; and the like; coordination of patient bed and transportation facilities within larger municipal, regional, and national healthcare networks, and additional healthcare-related systems without limitation. API 107, therefore, comprises software instructions integrating any combination of these example and additional decentralized hospital systems 102, in some embodiments.

API 107, by collecting and processing substantially all data from data inputting devices 108, filters out irrelevant “background noise” data, while prioritizing and organizing the most humanly manageable, important, immediately relevant data for presentation to a manager of decentralized hospital system 102 via an operator workstation 120.

Each decentralized hospital system 102 of hospital operations system 100 comprises, in some embodiments, an operator workstation 120. Operator workstation 120 functions as the management point for an individual decentralized hospital system 102. Operator workstation 120 is staffed by an operator, and comprises, in some embodiments, a hospital system software 154 operating on a first workstation computing device 150. In some embodiments, hospital system software 154 comprises an enterprise software 152. In some embodiments, hospital system software 154 comprises a middleware 153. In some embodiments hospital system software 154 comprises a glueware 155.

In some embodiments, operator workstation 120 comprises a user interface 156. The human operator interfaces with hospital operations system 100 via operator workstation 120, wherein the operator receives data, such as on a standard computer monitor or similar device, for example. In some embodiments, the operator makes decisions and may act upon these received data by inputing instructions to hospital operations system 100 via user interface 156 of operator workstation 120.

In some embodiments, hospital operations system 100 additionally comprises a simulation center 140. Simulation center 140 comprises, in some embodiments, a simulation software 141 operating on first workstation computing device 150, a simulation data bank 142, and a simulation data interface 143. In some embodiments, simulation software 141 utilizes data comprising simulation data bank 142 to create hypothetical critical scenarios requirement user management of a single decentralized hospital system 102, coordinated management of a plurality of interconnected decentralized hospital systems 102 comprising hospital operations system 100 to provide users of operator workstations 120 with realistic, high-level training in the management of critical events. Some non-limiting examples of critical events include cardiopulmonary arrest or other patient emergencies, a plurality of simultaneous patient emergencies, a regional mass-casualty situation such as an airplane crash, a large building fire, an earthquake, or a terrorist attack; break-down of critical hospital equipment; depletion of patient care or other hospital renewable supplies; acute unplanned shortages of healthcare providers and other hospital staff; an infectious disease epidemic or pandemic; and the like.

FIG. 2 additionally shows an example layout of operator workstations 120, including operator workstation 120 for an Operations Director (“OD”) and an Emergency Coordinator (“EC”). HOS operator workstations 120, in some embodiments, are assigned specific domains to enhance communication and increase productivity. Operator workstation 120 is, in some embodiments, comprised of a chair, desk, headset, keyboard, computer, and multiple monitors (to enable multi-tasking). The computer may include a processor, a memory, and a hard drive. The computer may also be in network connection with other computers of other workstation computing devices, as well as other computers, hardware, and systems in the hospital. The combination of equipment and assigned domains provides multi-function communication using the right tools to accomplish assigned tasks.

Examples of such assigned tasks, in some embodiments, include direction of operations, emergency coordination, resource management, patient planning and scheduling, patient physiological monitoring, network and equipment monitoring, and the like. OD Workstation computing device: enables the OD to provide team management, leadership and the interfaces to hospital management and external agencies for emergency coordination. This workstation computing device also provides the same functions as the workstation computing device for the emergency coordination.

EC Workstation computing device: enables the EC to direct emergency response activities including coordination for intra-hospital, inter-hospital, and other emergency responders and team management and leadership.

Resource Manager (“RM”) Workstation computing device: enables the RM Coordinator to coordinate hospital staffing, logistics, supplies, and asset tracking.

Patient Planning and Scheduling (patient management or “PM”) Workstation computing device: enables the PM Coordinator to perform activities related to patient admission, bed management, patient location tracking, family services, and patient discharge.

Patient Physiological Monitor (patient data monitor or “PDM”) Workstation computing device: enables the PDM to perform activities related to real-time monitoring of patient physiology data points, trend monitoring, audio and video monitoring, communication with and mobilization of emergency responders, and access to patient laboratory and other test results.

Network and Equipment Monitor (“NEMO”) Workstation computing device: enables the NEMO to perform activities related to monitoring of the hospital Internet of Things (IoT), network mapping, equipment, devices, physical plant, and security systems.

Operator workstation 120 of HOS 100, in some embodiments, has the ability to receive information and data from all hospital systems and software that correspond to that particular workstation computing device. The HOS provides an interface that allows the various software applications from the hospital systems to communicate and provides the HOS with the ability to receive and view all data from the hospital systems and software to enable the workstation computing device to properly monitor and determine tasks that should occur based on the monitored information received by a workstation computing device of the HOS.

The HOS provides an interface to a hospital simulation system, including the ability to collect, store, protect, and disseminate real-time data for the purpose of recreating specific real-world scenarios in a simulation environment.

The HOS may include application programming interface 107 operating on a centralized server or servers, wherein the server includes a processor, memory, a hard drive and database structure, and software products. In particular embodiments, the software products may be a type of software for each workstation computing device to collect and process information from various hospital systems and display and communicate with the various hospital systems from a centralized location. The software products may include an application programming interface (“API”), middleware, glueware, or various combinations thereof.

An API is a an application programming interface that includes a set of routines, protocols and tools that provides instructions as to how certain software components interact and communicate with one another. The API is utilized to allow various software applications of the hospital systems to communicate with one another, in some embodiments. These software applications may be pre-existing software applications that are common for a particular hospital operation or function.

In some embodiments, operator workstation 120 comprises enterprise software 152. In some embodiments, operator workstation 120 comprises a management software 157. In some embodiments, operator workstation 120 comprises middleware 153, wherein middleware 153 is, in some embodiments a software product that provides the instructions necessary to connect a plurality of software application comprising a decentralized hospital system 102 of the HOS 100 with enterprise software 152. Enterprise software 152 comprises, in some embodiments, instructions information processing functions upon data communicated from data inputting devices 108 using middleware 153. In some embodiments, middleware 153 is existing software which is commercially available. In some embodiments, middleware 153 is specific to decentralized hospital system 102 of HOS 100 and is not commercially available.

In some embodiments, operator workstation 120 comprises glueware 155. Glueware 155, in some embodiments, is a software product that integrates decentralized software applications and systems into an integrated environment, regardless of the software type and developer. In these and similar embodiments, a hospital system may utilize various software applications and systems throughout the hospital and the glueware “glues” each of the different software applications and systems together so they can communicate with each other and operate as an integrated system. In some embodiments, operator workstation 120 of HOS 100 comprises user interface 156 deployed on operator workstation 120. Glueware 155 couples a plurality of software applications and systems with workstation 120.

In some embodiments, HOS 100 comprises a video wall 113 comprising a plurality of monitors communicatively connected to API 107 of HOS 100. Video wall 113, in some embodiments wherein provided, enables immediate and efficient team situational awareness. Video wall 113 displays critical information derived from operator workstations 120, API 107, or both operator workstations 120 and API 107 for simultaneous viewing by the entire team and observers. Video wall 113 allows HOS operators and other team members to interact in a coordinated manner, thereby responding to alarms, events, and developing situations with increased efficiency.

In a non-limiting example of video wall use, video wall 113 displays data associated with an emergency response scenario. The team interfaces with HOS 100 data inputting devices 108 to continue normal hospital operations, while simultaneously tracking emergency scenario developments on the video wall.

In some embodiments, the OD selects what information is displayed on the video wall and instructs an operator of operator workstation 120 to display information on the video wall. This may occur by mirroring the information on workstation computing device to the video wall or by other suitable means of displaying the data from the workstation computing device to the video wall.

In some embodiments, information displayed on video wall 113 is automatically displayed based on certain event triggers determined by API 107 of HOS 100. For example, an event trigger may be determined for a particular hospital and customized to reflect pertinent data. If an emergency situation occurs, this may be an event trigger that automatically initiates the display of certain information regarding the emergency event. These data may include input from operator workstations 120 as they relate to the emergency situation. This allows the OD to see all hospital functions working on the triggering event simultaneously.

Regarding communications, HOS 100, in some embodiments, provides an open voice loop, video teleconferencing, and equipment communication monitoring, and related communications capabilities. Communication, including verbal and electronic communication—among operators and between operators and non-HOS hospital staff—facilitates optimal functioning of HOS 100.

Efficient and unencumbered communication is provided by open-voice loop with video capability using the hospital's existing communications network or a new network. This open-voice loop facilitates quick and easy communication both within the HOS and with other hospital staff through time-saving features (e.g., auto/speed dialing, contact lists, search routines, video conferencing, and conference calling). The hospital's communications network is integrated with HOS 100, in some embodiments.

HOS 100 comprises video teleconferencing capability with any computer terminal in the hospital for one-on-one and group video conference calls, in some embodiments. This capability is especially useful for assessing verbal and nonverbal cues indicating the ability of personnel to respond effectively to challenging situations and stressful conditions.

HOS 100 comprises an executive briefing room 111, in some embodiments which can be used as a conference room, response center, or crisis center. Executive briefing room 111 can be utilized during major emergency situations, an internal near-miss requiring investigation, or a planned rehearsal of particular processes. In some embodiments, executive briefing room 111 functions as a “go-to point” for community leaders, regional care providers, first responders and law enforcement in case of a local or regional disaster. Executive briefing room 11 has the ability to display a patient's current physiological data, medical records, and trending of medical data.

In some embodiments, HOC 100 additionally comprises an observation and visiting room 112. Observation and visiting 112 may comprise several functions, including, but not limited to allowing hospital administrators and executives to monitor the real-time operations of their hospital; family visualization of HOS 100 functions and associated technologies at work monitoring and caring for their loved ones; and visiting dignitary visualization of real-time operations and benefits of HOS 100.

### HOS Capabilities

A note on Capabilities versus Functions: Capabilities of HOS 100 are comprised of, but not limited to, various functions (see Table 1). Capabilities are related to stakeholder needs and are typically comprised of multiple functions. Individual functions are often utilized by multiple capabilities and are typically considered an individual activity or effort.

In some embodiments of HOS 100, the capabilities include, without limitation: 1) management of patient flow from admission to discharge; 2) management of hospital computer networks, including equipment and software performance; 3) management and monitoring of patient physiological data; 4) management and monitoring of hospital resource availability and usage; 5) provision of a platform comprising infrastructure, equipment, and software for telemedicine; 6) management of adverse events and “near misses; 7) management of hospital-wide data and provision of situational awareness; 8) coordination and management of emergency response teams in crisis situations; and 9) management of an interface between hospital operations and the simulation center. Each of the aforementioned capabilities utilizes software applications and/or hospital systems relevant to each capability. In some embodiments, the general overall scope of each of these capabilities comprises the following:

### 1) Management of Patient Flow from Admission to Discharge

In some embodiments, the goal of HOS 100 includes optimizing resource utilization, reducing wait times, and improving patient safety and hospital efficiency. The capability may include admissions, bed management, patient location tracking, transportation, and discharge. The HOS positions that may be required include PM coordinator (SCHEDULER) and resource management (RM) coordinator (RESOURCE). Optimizing resources improves patient care, patient location tracking, patient safety and patient/family satisfaction while reducing waiting times.

In some embodiments, HOS 100 provides continuous real-time information on a patient's physical location in a hospital by using radio frequency identification (RFID). Tracking a patient's physical location enables healthcare professionals (HCP's) to control patient flow and the progress of each individual patient's care. Tracking a patient's physical location in a hospital adds to a patient's and the patient's family's satisfaction with the hospital experience by minimizing wait times throughout the progression of patient care. Hospital patient traffic and flow is more efficient through tracking of patient location.

In some embodiments, HOS 100 provides and displays real-time statistics to operators on bed and other resource availability for each of the hospital's distinct functional areas. These statistics include available beds, occupied beds, required beds; patients awaiting bed placement; ingress method (e.g., in-patient transfer, emergency room, operating room, labor and delivery, walk-in, and clinic transfer); and projected and imminent discharge dates. These statistics improve the accuracy and efficiency of patient triage and placement.

### 2) Management of Hospital Computer Networks, Including Equipment and Software Performance

A goal of managing network, equipment, and software performance is to ensure that the status of each element of the system accurately reports data at all times. State-of-health system diagnostic data from the hospital network, hospital Internet of Things, equipment, and software is updated by HOS 100 as necessary, and HOS 100 personal are automatically alerted if any system is operating outside of predetermined optimal parameters, in some embodiments. The Network and Equipment Monitor (“NEMO”) is the primary position within the HOS responsible for network, equipment, and software performance management.

### 3) Manage and Monitor Patient Physiological Data

The goal of physiological data monitoring is to provide an integrated view of the patients' health. The primary position in the HOS who participates in physiological data monitoring is the Patient Data Monitor (PDM).

Hos 100's central monitoring of physiological data, in some embodiments, provides additional support to the HCP's at the bedside through the detection of trends in patient status, thus enabling early detection of and intervention for evolving problems, reducing the incidence of rapid response and code team calls.

### 4) Manage and Monitor Hospital Resources

The goal of hospital resource management includes managing and tracking the status of hospital resources including staffing, equipment, and supplies. The capability scope includes staffing schedule coordination, equipment management, supply management and logistics. The HOS position who participates in this function is the RM.

Working in conjunction with existing hospital resource organizations, the HOS applies logistical analysis of all available data to ensure optimal resource utilization.

### 5) Provide Telemedicine Software and Infrastructure

In some embodiments, HOS 100 supports telemedicine and telemonitoring services by providing the required transmit, transport, and receive systems to effectively interface with a centralized operations system. This telemedicine infrastructure provides HOS personnel with the ability to make timely healthcare decisions based on real-time actionable data.

With current systems, it is understood that limitations in the ability to provide physicians with accurate, timely, actionable real-time data from a remote location with an underdeveloped communications infrastructure. Without this data, it may be more difficult to diagnose patients with high confidence. Developing a reliable, portable communications infrastructure would radically improve telemedicine capabilities for HCPs in remote locations. In some embodiments, HOS 100 provides a reliable, portable communications system that can be used to transmit real-time data between a remote location and a host telemedicine terminal at HOS 100. This capability includes identification of data the physician requires to remotely diagnose the patient (including physiological parameters, audio, still or video images, etc.); data collection; data uplink and transport; data display at operator workstation 120; data dissemination to HCP portable devices such as a smart phone, tablet, etc.; and data storage with playback.

### 6) Manage Adverse Events and “Near Misses”

The goal of Adverse Event and Near Miss Management is to identify and isolate the events, determine possible causes of the errors, and minimize future occurrences. In some embodiments, HOS 100 improves anticipation, detection, analysis, and mitigation of near misses and adverse events. The data collected for near miss and adverse event recreation is stored in a controlled, monitored environment. The data is used to assess operational procedures and processes, perform post-event analysis and upgrade healthcare team training with identified error mitigation techniques.

### 7) Manage Situational Awareness of Hospital-Wide Data

The goal of Situational Awareness Distribution is to rapidly inform hospital personnel, including nurses, doctors, management, and the like about current hospital operational status with appropriate, relevant information. The capability includes customizable portals with regularly updated and aggregated data. The primary position in the HOS who coordinates hospital situational awareness distribution is the OD, however, the system of distribution will generally be automated and applied to any HOS 100 staff position. In some embodiments, HOS 100 also provides a real-time interface with senior hospital administrators by providing timely performance and situational awareness status updates. This capability can also be expanded to provide current information to patients and patient families.

### 8) Manage and Coordinate Emergency Crisis Response

In some embodiments, HOS 100 serves as an emergency response command and control center, as required by local and regional emergency scenarios. In some embodiments, HOS 100 improves current emergency response capabilities by providing a more sophisticated monitoring and communications infrastructure. In some embodiments, HOS 100 readily transitions into an Emergency Response Central Command Center during times of natural disaster, emergency response, or other crisis periods. Additional personnel are called in at the Operations Directors request to augment the HOS operators. This capability improves on current emergency response by providing a sophisticated monitoring and communications infrastructure that is already in place when a crisis occurs.

### 9) Manage Interface Between Operations and Simulation Center

In some embodiments, HOS 100 enhances the safety, efficiency and effectiveness of patient care through its ability to collect, store, protect, and disseminate real-world system data into the hospital simulation facility. Through the re-creation of actual operational scenarios the hospital's simulation team is able to analyze human and system performance and rapidly provide recommendations for addressing any weaknesses that are manifest.

Current healthcare simulation capabilities use high-tech simulation devices, but apply only rudimentary source data and basic planning, coordination, and debriefing techniques. The results are inefficient, expensive simulations that do not markedly improve hospital operations.

In some embodiments, HOS 100 provides the healthcare simulation planning team with a structured mechanism for planning, operating, and evaluating simulation exercises by delivering functionality that includes the identification of real-time operations data; task collection of real-time data; collect real-time data; store real-time data; protect data (remove HIPAA data); disseminate data to simulation nodes; playback data during a simulation event; record team performance data during simulation; provide means for structured debriefings; apply lessons learned to update training, procedures, interventions and risk mitigation techniques; and archive all data.

In some particular embodiments of HOS 100, all data collected and/or monitored by HOS 100 may be stored. Storage of such data may be time or chronologically driven, meaning that at certain predetermined times, the system records and stores data. Other embodiments may include event triggers, wherein if a predetermined event occurs, the system operates to record and store data with regard to a particular patient and the like. In some embodiments, and based on storage capacities, the stored data for simulation exercises are stored for a predetermined period of time. If that data is desired to be stored longer, a user may actively save that particular data set to another memory device for storage.

### HOS 1000 Functions

In some embodiments, HOS 100 is a multi-domain, multi-activity, integrated approach to healthcare. HOS 100 facilitates the delivery of safe, effective and efficient care by HCP's while also enhancing the overall experience of the patient and the family. The HOS accomplishes these improvements as a central operations system that manages and monitors key activities for patient care (location, physiologic data, telemedicine/telemonitoring, and near misses/adverse events) and key service-related items (bed availability, equipment, supplies, emergency response, and simulation). This integrated approach is accomplished through HOS 100's individual functions (Section 4), facilities (Section 5) and staff (Section 6). It should be appreciated that, in some embodiments, HOS 100 operates to receive and monitor data from the hospital software applications and systems as they occur in real-time. This allows HOS 100 to monitor all aspects of function and operations of the hospital as they are occurring, allowing for the most up-to-date information to improve efficiency in the operation of the hospital services.

In some embodiments, HOS 100 comprises twenty-two primary functions contributing to the implementation of the nine capabilities; each of which comprises goals and associated personnel.

### Patient Planning and Scheduling

This function includes monitoring patient intake, room assignment, and monitoring equipment at the time of admission and reassigning resources as the patient progresses through his/her hospital stay. In some embodiments, HOS 100 is responsible for tracking a patient location and schedule from admissions through discharge. In some embodiments, HOS 100 conducts real-time, continuous assessment of patient progression through the hospital, including movement from one area to another (e.g., pre-op area to the operating room to an intensive care unit) and the associated waiting times in these areas. In some embodiments, HOS 100 uses thesedata to improve patient flow through the system, reducing waiting times and optimizing resource utilization and thereby increasing patient and family satisfaction.

### Bed Management

Optimizing resource utilization is also accomplished by real-time, continuous insight into bed availability as part of an integrated view of hospital resources. Tracking bed availability by HOS 100, in some embodiments, improves the accuracy and efficiency of patient triage and placement. Hospital personnel immediately know which beds are available for use. Bed availability is determined through data analysis performed in HOS 100 using a number of variables and data input from the PM coordinator. Non-limiting examples of these variables, in some embodiments, include total number of beds, occupied beds, available beds; patient method of influx (e.g., scheduled admissions, unscheduled walk-ins); scheduled patient influx (including emergency room and operating room patients); unscheduled patient admissions; projected discharge dates and number of imminent discharges; number of patients waiting for beds.

### Patient Location Tracking

Patient location tracking in HOS 100, in some embodiments, optimizes efficiency, patient safety, and patient satisfaction through real-time continuous assessment of a patient's physical progression through hospital departments and locations (e.g., a patient's movement in physical location from pre-op to the operating room to a care unit). Efficiency of hospital patient traffic and flow is optimized through tracking of each patient's location.

In some embodiments, HOS 100 provides continuous real-time information on a patient's physical location in a hospital by using a device, such as a radio frequency identification device (“RFID”) in one non-limiting example. Other patient location tracking devices comprise HOS 100, ins some embodiments. Tracking a patient's physical location enables healthcare professionals (HCP's) to control the progress of patient care. Tracking a patient's physical location within the healthcare complex adds to a patient's and the patient's family's satisfaction regarding the hospital experience by minimizing wait times throughout the delivery of patient care.

### Transportation Management

Transportation improves patient care and satisfaction through the safe and timely transport of patients to the correct location. The transportation function encompasses transport to both intra-hospital locations (within the hospital) and inter-hospital locations (between hospitals or between a hospital and associated clinics).

This function provides an interface with intra-hospital and inter-hospital organizations and personnel while providing data to HOS 100 in a timely manner. In some embodiments, HOS 100 interfaces with both internal and external transportation organizations (including registered nurses for critical care pediatric patients) to coordinate the safe transportation of a patient between locations. Scheduling of transportation to and from non-moveable resources (e.g., CAT scan, X-ray, or decompression chambers) and ensuring that patients arrive and depart on schedule is a key internal activity. An important external transportation activity is managing the movement of a patient requiring a higher level of care from a small rural or suburban hospital to an urban referral center, with subsequent coordination of continued care by the patient's local healthcare institution(s) and provider(s) as the time for discharge approaches.

### Physiological Data Monitoring and Analysis

Physiological data, obtained from medical monitoring equipment coupled to a patient, is captured and processed by a suite of software. This physiological data is presented to HOS 100, in some embodiments, in a variety of formats, based on the operator's needs. In some embodiments, HOS 100 has the ability to monitor a patient at a very high level (stop light chart) and to drill down into detail to perform short- and long-term trending of patient physiological data.

The goal of physiological data monitoring is to provide an integrated view of the patients' health. This goal includes data collection and monitoring of hospital inpatients and outpatients, and collection of aggregated data from medical devices to obtain a complete picture of the patient's current status. These aggregated data include patient video and audio feeds emanating from clinical areas within the hospital, telemedicine services interfacing with remote institutions, and telemonitoring. Trending data is an important component of physiological data monitoring. Providing trending data enhances the speed with which appropriate personnel are notified of significant changes in patient status, allows for earlier patient care intervention, and reduces the need for activating emergency responses (“calling a code.”) The HOS performs passive short-term trending of data, and issues multiple levels of severity-based alarms to the Physiological Monitor. The Physiological Monitor acknowledges the alarms, investigates the issue, and escalates the issue to the HCP as necessary.

Short-term trending allows for the early identification of scenarios requiring intervention, thus reducing near misses and adverse events. Long-term trending of medical data is also performed to provide the medical staff with an integrated long term view (hours, days, weeks) of the patient's health. This data is accessible to both HOS 100 operators and to the medical staff in charge of care for that particular patient, while adhering to HIPAA laws and patient privacy, in some embodiments.

In some embodiments, HOS 100 operators access audio and video streaming from various areas of the hospital system. These data streams are available in real-time and also archived for later review. Such data is used to augment the capacity of the HCP's at the bedside to recognize evolving trends and maintain situational awareness throughout the hospital system.

In some embodiments, HOS 100 allows the operator to manage multiple clinical data streams, including patient test results, and ensure timely responses to alerts associated with critical values.

Telemedicine Data Collection, Transport and Reception

In some embodiments, HOS 100 collects telemedicine physiological data from various participating sources including, without limitation, external regional medical centers, home healthcare, and mobile clinics. The data is communicated to HOS 100 via existing satellite, cell communication networks, internet connections, or hardwire telephone connections.

EHR/EMR Interface

In some embodiments, HOS 100 systems interface with the hospital's existing EHR/EMR systems and provide an integrated view of the patient's health to the operator.

Operations Data Management

In some embodiments, HOS 100 manages all operations data flowing across the hospital networks including, without limitation, scheduling data, physiological data, administrative data, system diagnostic data, real time status data, training data and any other data relating to current day-to day operations.

Financial and Insurance Interfaces

In some embodiments, HOS 100 interfaces with financial and insurance institutions to facilitate the funding of patient care. This interface allows hospital administrative personnel access to vital and necessary data related to their fiscal and fiduciary responsibilities.

Infrastructure Equipment Management and Control

In some embodiments, HOS 100 monitors and manages the hospital's internal networks, databases, and storage devices, which includes hardwired and wireless networks and equipment. This infrastructure is used to collect, store, and disseminate health and status data, as well as physiological data from the medical equipment. Included in this data are audio and video signals being transmitted from various environments within the hospital. HOS 100 monitors the connectivity and quality of these signals, in some embodiments.

Medical Device Management and Control

In some embodiments, HOS 100 monitors and controls the system health and status of all medical equipment assigned to a patient in a hospital care area. This equipment is tied to the hospital LAN, and HOS 100 verifies that the equipment is continuously on-line, powered, and operational, in some embodiments.

Facility Management

In some embodiments, HOS 100 provides the interface to monitor and control essential hospital facility and facility systems such as primary and backup power systems. Facility Management also includes the management of power systems, HVAC systems, space, and cable routing in equipment locations.

Site Security Management

Security systems are monitored centrally in HOS 100, in some embodiments. Security systems include, for example, physical security, internal computer and network security, hospital security, and any external cyber security.

Staff Scheduling

In some embodiments, HOS 100 coordinates with the hospital staffing organizations on resource assignments. Information obtained from the patient planning and scheduling function is used in conjunction with personnel availability information to generate coordinated staffing schedules and analyze existing schedules for gaps in coverage. This function allows the hospital to optimize staffing efficiency by having proper staff available as required by patient planning and scheduling.

Asset Management

In some embodiments, HOS 100 tracks the location and status for medical devices used for patient care. This includes both portable and fixed-location equipment. This location and status information is made available for use by the operators performing the patient planning and scheduling function, as well as appropriate hospital personnel inquiring about the devices.

This function provides HOS 100 personnel with the ability to maintain a satisfactory level of asset availability. This function includes adding new equipment to the pool list, removing obsolete or faulty equipment, and ensuring returned equipment is noted as available in the pool once it has been repaired or replaced. This availability pool is managed by patient planning and scheduling when assigning equipment to patients, in some embodiments.

The incident reporting system is used to identify and track issues with the hospital's medical equipment. An incident report is created as soon as an issue with a piece of medical equipment is identified. The issue is logged and tracked all the way through its resolution.

Situational Awareness Data Reporting

The goal of Situational Awareness Distribution includes to rapidly inform hospital personnel (nurses, doctors, management, etc.) about current hospital operational status with appropriate, relevant information. The functional areas include customizable portals with regularly updated and aggregated data. Data collected and stored in HOS 100, in some embodiments, is distributed to hospital staff as relevant real-time information (staffing levels, projected census levels, patient acuity distribution, etc.) in a customizable format appropriate to the respective personnel's need to know.

HOS 100's data is distributed to hospital leadership as relevant information (performance and efficiency metrics, patient flows and satisfaction levels, safety violation counts, upcoming regulatory events, etc.) in a customizable format appropriate to the respective personnel's need to know. HOS 100's data can also be distributed to patients and their families so they are continuously aware of the patient treatment plan and schedule, in some embodiments.

Emergency Communications

During local emergencies such natural disasters or acts of terror, HOS 100 functions as an Emergency Response Central Command Center, in some embodiments. For example, this function provides coordinated emergency response to effectively deal with the driving event. The Emergency Coordinator position is the primary communications interface between the hospital and internal and external organizations and specifically communicates with first responders, law enforcement, FEMA, state & local agencies, and if necessary, the general public. The Emergency Coordinator manages emergency communications and situational awareness with a common operating picture for regional, state or local occurrences.

Emergency Data Distribution

In an emergency scenario requiring this function, maintaining and managing situational awareness is critically important. This scenario will drive other functions of HOS 100, in some embodiments, such as patient planning and scheduling as well as managing hospital situational awareness via relevant data distribution with a common operating picture for regional, state or local occurrences.

Secure Data Storage

This function involves collecting, storing, and protecting all data received by HOS 100, in some embodiments. This collected, stored, and protected data includes physiological data, equipment status data, bed management data, audio, visual, and patient planning and scheduling data. This data will be archived for a predetermined number of days, and will be stored in a format where it is readily retrievable by HCP's on request, as well as the simulation team.

Simulation Center Data Interface Management

In some embodiments, simulation center 140 of HOS 100 provides the hospital simulation team with the data necessary to recreate, in a highly realistic manner, real-world near misses and adverse events. This allows for analysis by a multidisciplinary team and development of strategies for the prevention of such events in the future.

Internal Voice and Data Communication

In some embodiments, HOS 100 comprises a communication network internal to the hospital via various sources to relay messages, instructions, alerts, requested information, etc. This network includes, without limitation, the use of email, text messaging, voice (cell, landline, VoIP, mobile headset communication links, etc.), and video (video phone call, web cam, etc.).

External Voice and Data Communication

In some embodiments, HOS 100 comprises a communication network external to the hospital for participating medical entities via various sources to relay messages, instructions, alerts, requested information, etc. This network includes, without limitation, the use of email, text messaging, voice (cell, landline, VoIP, etc.), and video (video phone call, web cam, etc.).

Embodiments of Hos 100 may include the centralization of monitoring all of the functions discussed above in one location of Hos 100. This monitoring may be separated into various workstation computing devices as previously discussed in order to best monitor and analyze the data being provided to Hos 100. All communication sent from HOS 100 to various locations and staff and healthcare professionals may be done so automatically by the systems or may also be sent manually from a person at a workstation computing device through Hos 100.

Hospital Staffing

In some embodiments discussed herein below, six specialized positions may perform the work necessary to monitor HOS 100's capabilities of patient planning and scheduling, physiological data monitoring, network and equipment monitoring, hospital resource management, emergency response coordination, and collection and storage of near-miss and adverse event data. The key responsibilities of each position are described below. Each position is staffed 24/7, with the exception of the EC. Operators may be assigned to multiple positions during periods of slow activity based on cross-training and domain expertise. A position summary is provided in Table 1.

TABLE 1
HOS Position Summary

| Position | Function |
|---|---|
| Operations Director (OD) | Overall operations authority |
| Physiological Monitor (PHYSIO) | Monitoring and responding to |
| | patient physiological data |
| Network and Equipment Monitor (NEMO) | Monitor medical equipment |
| | and hospital networks |
| Patient Planning and Scheduling | Coordinating patient flow and |
| Coordinator (SCHEDULER) | bed management |
| Resource Management Coordinator | Coordinating resource |
| (RESOURCE) | utilization |
| Emergency Coordinator (EC) | Coordinate emergency |
| | response |

The OD's responsibilities include providing overall operations and management authority; providing leadership and guidance to the HOS staff; acting as liaison to hospital administration; investigating near misses; and leading emergency response activities when the EC is not available.

The OD provides overall authority, leadership and guidance for all HOS operations and management activities and personnel and is the liaison to hospital administration and management. The operations director manages HOS activities to ensure HOS capabilities, personnel, and equipment support for day-to-day patient care and response to emergency situations.

Key responsibilities of the PHYSIO include monitoring alarms, warnings, and events associated with a patient's physiological data; monitoring patient/room audio/video data; accessing patient test results; reviewing short-term and long-term trending on a patient's physiological data; escalating and documenting issues to the attending physician and nurse via the OD; escalating medical equipment issues to the responsible parties; coordinating with the OD on major changes in a patient's condition; accessing EMR's; and ensuring adherence to Health Insurance Portability and Accountability Act (“HIPAA”) and patient privacy laws.

The number of PHYSIO operators and workstation computing devices is based on the patient volume and types of clinical units within the hospital.

Key responsibilities of the NEMO are monitoring alarms, warnings, and events associated with medical equipment and networks; reviewing short-term and long-term trending of medical equipment and networks; escalating and documenting issues to the attending physician and nurse via the operations director; identifying, managing, tracking, and resolving equipment malfunctions; and monitoring physical plant and security systems.

The number of NEMOs is based on the number of medical devices and non-medical equipment being monitored.

Key responsibilities of the SCHEDULER are coordinating admission of incoming patients; managing pooled resources (i.e., rooms and equipment such as beds and monitors); assigning resources at patient admission, throughout the patient stay and at patient discharge; managing bed control; maintaining and coordinating the master schedule of patient events and locations; coordinating patient transport; and providing patient location tracking information to hospital staff, patient, and family members.

The number of SCHEDULERs is based on the typical volume of incoming patients and the number of patients within the hospital.

Key responsibilities of the RESOURCE are managing optimal operational 24/7 staffing levels; tracking in-hospital, on-call, call-in, shift schedule, and on-vacation rosters for physicians, nurses, allied HCP's, support personnel and all other hospital staff; tracking the location and status of all hospital equipment and devices; maintaining an inventory of medical equipment, including condition, status, and repair history; providing hospital supply logistics; and coordinating equipment repair with vendors.

The RESOURCE assists in managing hospital staffing levels for physicians, nurses, allied HCP's and other hospital staff. The RESOURCE tracks staff on duty, as well as their specialty, location, shift schedule, and contact information in order to maintain appropriate staffing ratios. In doing so, the RESOURCE also accounts for the staff's long-term job satisfaction and cost reduction.

The RESOURCE tracks the location and condition of all hospital medical equipment and devices and maintains an equipment inventory including condition, current location (e.g., operating room, patient room, and storage), status, and repair history.

The number of RESOURCEs is based on the current number of staff members and the number of pieces of medical equipment and devices.

The EC position is staffed 24/7 during a natural disaster, emergency response, or other crisis event. The EC position is fulfilled at the behest of the OD. Key responsibilities of the EC are management of intra-hospital emergencies (e,g., fires, power failures, patient abductions, etc.), inter-hospital emergencies (including mass casualty triage, transport and treatment) and coordination of other types of emergency response activities with other hospitals and clinics; first responders (fire, police, and emergency medical services); city, county, state, and federal agencies; disaster relief organizations; and media and public relations; and provision of system-wide situational awareness during local, regional, state and national emergencies.

When the EC is on duty, he/she is assigned a single workstation computing device that provides access to the hospital communication system and logistics and supply data.

Hospital Operations system Example

The following is only a non-limiting example provided to show how the HOS 100 may facilitate patient planning and scheduling, physiological data monitoring, network and equipment monitoring, hospital resource management, and emergency response. It is not intended to be a limitation to any feature or component of the invention.

Patient Admission

A patient arrives at the hospital and is checked in by the admissions office staff. After the patient intake data is entered into the hospital admissions system, HOS 100 automatically and electronically notifies the SCHEDULER and the RESOURCE of the new patient's arrival. Based on the data obtained from the admission intake process, the SCHEDULER allocates a room, bed, and equipment to that patient and coordinates the transportation of that patient to the assigned room. This task is accomplished using the HOS's patient scheduling system, wherein the computer operates to execute instructions of code to effect this element, including the auto-notification of the arrival of a new patent. The electronic notification may be sending a message to an electronic device of the SCHEDULER and the RESOURCE. In some embodiments of HOS 100, the patient scheduling system is an existing software application that is tied to the HOS 100's database structure, wherein Hos 100 includes middleware that provides the data from the scheduling system to operator workstation 120.

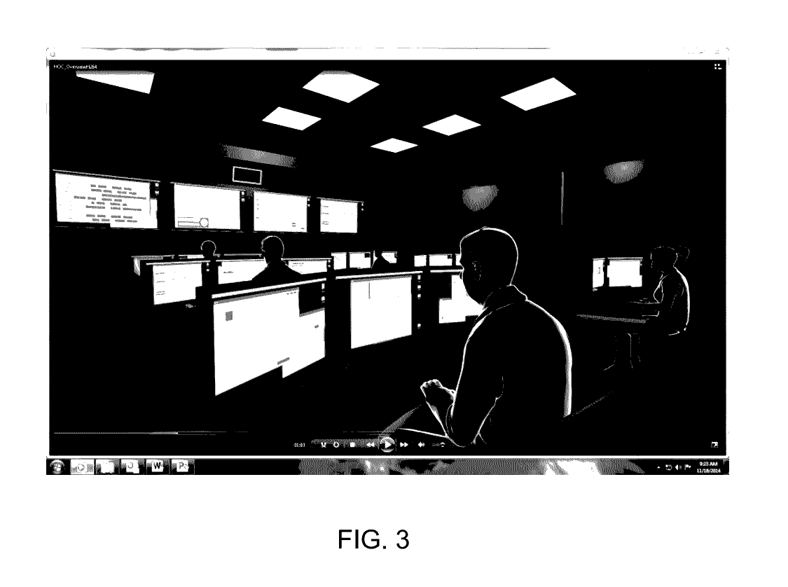

Referring to the drawings, FIG. 3 graphically depicts an example of typical patient monitoring and transportation.

Patient Monitoring

Once the patient is in a room and connected to medical monitoring equipment, the PHYSIO monitors the patient's condition (as shown in FIG. 3), coordinating with the attending physician and nursing staff in order to set proper alert/alarm threshold values for the patient's condition. PHYSIO performs continuous passive monitoring of the patient's health, using both real-time (current status) data provided to the workstation computing device equipment of the PHYSIO from the monitoring equipment connected to the patient, and archived (short term—previous 15 seconds—and long term—last 12 hours) data. PHYSIO has access to all data streams pertinent to the patient—physiological monitoring, audio/video, and EHR/EMR. The PHYSIO workstation computing device, in some embodiments, utilizes existing software to communicate with and receive communications from monitoring device hardware. The HOS may include middleware with code formed of instructions performed by the workstation computing device to simultaneously analyze real-time data and compare the same with archived data while archiving the data streams received in real-time for later use. The archiving of this data is critical when it comes to simulation and system efficiency determinations.

PHYSIO and the OD work closely with the attending physician and nursing staff. When monitored values exceed pre-set alert/alarm thresholds, the HOS system automatically operates code that when performed by the HOS, informs PHYSIO, who analyzes trending data and equipment status and communicates with the HCP's at the bedside. An incident report is automatically created by the HOS system and updated by PHYSIO. If the HCP's at the bedside are unable to respond in an appropriate manner and timeframe, PHYSIO escalates the issue to the OD, who subsequently escalates the issue up the chain of command until it is resolved. This is accomplished more efficiently by utilizing the HOS system. This system puts all critical workstation computing devices into a central location allowing quicker communication as well as a full, overall view of all hospital systems at the same time, allowing for close monitoring of the incident report to ensure availability of proper resources and personnel to handle the situation. The HOS also records and archives in the HOS hard drive database structure all data relating to the incident.

The NEMO monitors the condition and status of the facilities and equipment utilized in the care of the patient. If an equipment item is faulty, the HOS automatically generates an alarm that must be acknowledged and an incident report is immediately created to track the issue. This automation is performed, in some embodiments, by the HOS software and communicated by execution of instructions contained within the software to all other workstation computing devices of the HOS. In some embodiments, the HOS registers the alarm status on the video wall, for visualization within the overall hospital context. The HOS operations team performs initial troubleshooting of the equipment, updates the incident report, and escalates the issue to the appropriate team. For simple situations, resolution may consist of notifying the bedside HCP responsible for the patient to address the problem. If the issue is more complex, it may require intervention by biomedical engineering, information technology, or other staff and the incident report is reassigned. If the equipment is found to be faulty, the NEMO coordinates replacement of the equipment and updates the incident report. The technician performing the repair provides the final resolution of the incident report based on his/her analysis and ability to repair the unit. If replacement is required, the RESOURCE coordinates with supply management staff to obtain a new unit.

Patient Transportation

During a hospital stay, patient transportation between various locations within and outside the hospital is often required. In this example, the patient is transported from his room to stationary MRI equipment for an imaging study. The HCP orders a specific test and this information is provided to the SCHEDULER via the HOS's scheduling system. The SCHEDULER schedules the test for the patient and coordinates transportation to and from the MRI scanner. In some embodiments, the HOS electronically notifies the proper staff to transport the patient. The HOS' s scheduling system continuously tracks the location and progress of the patient. If a patient is not at the appropriate location at the appropriate time, the HOS notifies the SCHEDULER who then contacts hospital staff to determine the cause of the delay and implement a solution. The SCHEDULER also manages the master schedule for the hospital's stationary equipment, including maintenance and repair schedules.

Patient Re-Assignment

In situations where a patient receives surgery or other major procedures, the patient is often reassigned to a recovery room following the procedure prior to being returned to her assigned room. Patient re-assignment begins with the HCP ordering a medical procedure. The SCHEDULER retrieves this information from the patient records through the network of workstation computing devices of the HOS and schedules the procedure, including the room, bed, equipment, and transportation. Depending on the length of stay in the new room, the old room, bed and equipment can be reintroduced into the pool of available resources.

The SCHEDULER monitors the transportation of the patient to the location for the procedure and also the status and availability of the scheduled rooms and equipment via the HOS scheduling system. The SCHEDULER monitors the progress of the procedure, including its expected time of completion. This information is used to coordinate the transportation of the patient from the procedure to the recovery room. The SCHEDULER is also responsible for ensuring that all of the requested monitoring equipment is available in the recovery room and in the patient's hospital room. The communication between patient scheduling, patient transportation, and equipment availability is linked through a network connection to the SCHEDULER workstation computing device. In this way, the HOS monitors and controls the scheduling and transportation of the patient.

Patient Discharge

Once the patient is approved for discharge, the SCHEDULER schedules transportation of the patient out of the hospital and then reallocates the discharged patient's room, including bed, monitoring devices, and other equipment, back to the pool of available resources contained within the scheduling system.

Network and Equipment Monitoring

The NEMO monitors the health and the status of all wired and wireless devices, tracking which equipment is operating normally, which equipment has faults or intermittent operational problems, and the current network map. This monitoring may be accomplished using existing software specific to the equipment being monitored. The HOS includes middleware to provide for collection of information by the HOS for analysis and archiving. NEMO coordinates with RESOURCE to track equipment make, model and serial number, and location via the network map. The NEMO coordinates operational equipment replacement with the biomedical engineering and/or information technology departments. The NEMO monitors all facility power, heating, ventilation, air conditioning, and equipment space data. The NEMO ensures backup power is available should primary power fail.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A hospital operations system comprising:
an application programming interface comprising a plurality of instructions operating on a computing device;
a plurality of decentralized hospital systems communicatively coupled to the application programming interface comprising at least two of an operations management system, an emergency coordination system, a resource management system, a patient planning and scheduling system, a patient physiological data monitoring system, and a network and equipment monitoring system, wherein each decentralized hospital system comprises
an operator workstation computing device comprising
a software application; and
a user interface, wherein the application programming interface comprises instructions communicatively coupling the workstation computing devices of the plurality of decentralized hospital systems and displays information to the operator of the workstation computing device;
a plurality of remote data inputting devices communicatively coupled to the computing device operating the application programming interface;
wherein the remote data inputting devices communicate remote data comprising patient physiological data, medical device operational status data, patient laboratory test data, patient radiology test data, hospital physical plant systems data, hospital equipment and supply inventory data; hospital equipment operational status data; patient scheduling data, hospital employee scheduling data; computer network monitoring data; community emergency systems response data; and combinations thereof;
wherein the computing device processes the remote data according to an instruction of the application programming interface, assigns a priority to each remote datum, and communicates the remote datum based upon the assigned priority to the software application of at least one of the operator workstation computing devices to comprehensively coordinate hospital operations between the plurality of decentralized hospital systems.

2. The hospital operations system of claim 1, wherein the computing device is communicatively coupled to a device comprising a decentralized hospital system, wherein the computing device changes an operation of the device.

3. The hospital operations system of claim 2, wherein the device is a medical device coupled to a patient.

4. The hospital operations system of claim 1, wherein workstation computing devices of the plurality of decentralized hospital systems are located in a single location.

5. The hospital operations system of claim 4, further comprising an observation area with a line-of-site viewpoint of the workstation computing devices.

6. The hospital operations system of claim 1, further comprising:
a second workstation computing device communicatively coupled to the application programming interface;
a teleconferencing interface; and
a conference room display communicatively coupled to the second workstation computing device and the teleconferencing interface, wherein the conference room display displays information from the plurality of decentralized hospital systems to a conference participant.

7. The hospital operations system of claim 1, further comprising a video wall comprising a plurality of monitors communicatively connected to the application programming interface.

8. The hospital operations system of claim 1, further comprising:
a simulation software application operating on the computing device;
a simulation data bank; and
a simulation data interface communicatively coupled with the application programming interface, wherein the simulation software application processes data stored in the simulation data bank to display a training scenario on the user interface, wherein the training scenario simulates critical events for training of an operator.

9. A hospital operations system comprising:
a second software application operating on a central server comprising
a processor;
a memory;
a database; and
a communications interface;
a plurality of remote data input devices communicatively coupled to the central server comprising patient physiological data, medical device operational status data, patient laboratory test data, patient radiology test data, hospital physical plant systems data, hospital equipment and supply inventory data; hospital equipment operational status data; patient scheduling data, hospital employee scheduling data; computer network monitoring data; community emergency systems response data; and combinations thereof;
a plurality of decentralized hospital systems communicatively coupled to the central server comprising at least two of an operations management system, an emergency coordination system, a resource management system, a patient planning and scheduling system, a patient physiological data monitoring system, and a network and equipment monitoring system, wherein each decentralized hospital system comprises
a workstation computing device comprising
a third software application; and
a user interface, wherein the second software application comprises instructions communicatively coupling the workstation computing devices of the plurality of decentralized hospital systems and displays information to an operator of the workstation computing device;
wherein the central server comprehensively coordinates hospital operations based upon the plurality of remote data input devices.

10. The hospital operations system of claim 9, wherein the central server comprises an enterprise software.

11. The hospital operations system of claim 9, wherein the central server comprises a middleware.

12. The hospital operations system of claim 9, wherein the central server comprises a glueware.

13. A hospital operations system comprising:
an application programming interface operating on a computing device;
a plurality of decentralized hospital systems, comprising
an operations management system;
a resource management system; and
any one of the group of systems consisting of an emergency coordination system, a patient planning and scheduling system; a patient physiological monitoring system, and a network and equipment monitoring system,
wherein the computing device is communicatively coupled to the plurality of decentralized hospital systems;
wherein the application programming interface provides instructions causing the plurality of decentralized hospital systems to coordinate any one of a flow of a plurality of patient care events, an ordering of hospital supplies, a scheduling of hospital employees and medical staff, a dispatch of a patient care provider in response to a change in patent physiological status; a transportation of a patient between physically distinct locations within a hospital system; a transportation of a patient between a physical location remote from a hospital system facility and the hospital system facility; and a coordination of a municipal emergency response system personnel.

14. The hospital operations system of claim 13, wherein each decentralized hospital system comprises a workstation computing device comprising a software application and a user interface, wherein the workstation computing device:
is communicatively coupled to the application programming interface;
displays information to a user through the user interface; and
receives instructional inputs from the user through the user interface.
